(19) United States
(12) Patent Application Publication
(10) Pub. No.: US 2021/0408605 A1
(43) Pub. Date: Dec. 30, 2021

(54) ELECTROLYTE SYSTEMS FOR LITHIUM-CLASS BATTERIES OF ELECTRIC-DRIVE VEHICLES

(71) Applicant: GM GLOBAL TECHNOLOGY OPERATIONS LLC, Detroit, MI (US)

(72) Inventors: Li Yang, Troy, MI (US); Bing Tan, Ann Arbor, MI (US); Umamaheswari Viswanathan, Troy, MI (US); Mary E. Fortier, Troy, MI (US)

(73) Assignee: GM GLOBAL TECHNOLOGY OPERATIONS LLC, Detroit, MI (US)

(21) Appl. No.: 16/910,174

(22) Filed: Jun. 24, 2020

(51) Int. Cl. H01M 10/0569; H01M 10/0567; H01M 10/0525; B60L 50/60

(52) U.S. Cl. CPC H01M 10/0569; H01M 10/0567; H01M 2300/0034; B60L 50/66; H01M 2220/20; H01M 10/0525

(57) ABSTRACT

Presented are electrolyte compositions with fluorinated cosolvents, methods for making/using such electrolyte compositions, and electric-drive vehicles with lithium-ion battery cells using such electrolyte compositions. An electrolyte composition for a lithium-ion electrochemical device includes a lithium salt, a nonaqueous solvent, and a fluorinated cosolvent. The lithium salt may include one or more soluble ionic salts, whereas the solvent may include one or more non-aqueous organic solvents. The fluorinated cosolvent includes a cyclic carbonate with a fluorine atom that is bonded directly to the cyclic ring, to a single atom bonded to the cyclic ring, or to a single side chain group bonded to the cyclic ring. The fluorinated cosolvent may be a fluoroethylene carbonate, a difluoroethylene carbonate, a trifluoropropylene carbonate, or a difluoropropylene carbonate. The side chain group may be an R-group, such as a 3-C chain, with at least one carbon atom bonded directly to the cyclic ring.

### INTRODUCTION

The present disclosure relates generally to electrochemical devices. More specifically, aspects of this disclosure relate to electrolyte compositions for rechargeable lithium-class battery cells of electric-drive vehicles.

Current production motor vehicles, such as the modern-day automobile, are originally equipped with a powertrain that operates to propel the vehicle and power the vehicle's onboard electronics. In automotive applications, for example, the vehicle powertrain is generally typified by a prime mover that delivers driving torque through an automatic or manually shifted power transmission to the vehicle's final drive system (e.g., differential, axle shafts, road wheels, etc.). Automobiles have historically been powered by a reciprocating-piston type internal combustion engine (ICE) assembly due to its ready availability and relatively inexpensive cost, light weight, and overall efficiency. Such engines include compression-ignited (CI) diesel engines, spark-ignited (SI) gasoline engines, two, four, and six-stroke architectures, and rotary engines, as some non-limiting examples. Hybrid electric and full electric (“electric-drive”) vehicles, on the other hand, utilize alternative power sources to propel the vehicle and, thus, minimize or eliminate reliance on a fossil-fuel based combustion engine for tractive power.

A full electric vehicle (FEV)—colloquially branded as an “electric car”—is a type of electric-drive vehicle configuration that altogether removes the internal combustion engine and attendant peripheral components from the powertrain system, relying solely on electric traction motors for propulsion and for supporting accessory loads. The engine assembly, fuel supply system, and exhaust system of an ICE-based vehicle are replaced with a single or multiple traction motors, a traction battery back, and battery cooling and charging hardware in an FEV. Hybrid electric vehicle (HEV) powertrains, in contrast, employ multiple sources of tractive power to propel the vehicle, most commonly operating an internal combustion engine assembly in conjunction with a battery-powered or fuel-cell-powered traction motor. Since hybrid-type, electric-drive vehicles are able to derive their power from sources other than the engine, HEV engines may be turned off, in whole or in part, while the vehicle is propelled by the electric motor(s).

Most commercially available hybrid electric and full electric vehicles employ a rechargeable traction battery pack to store and supply the requisite power for operating the powertrain's traction motor unit(s). In order to generate tractive power with sufficient vehicle range, a traction battery pack is significantly larger, more powerful, and higher in capacity (Amp-hr) than a standard 12-volt starting, lighting, and ignition (SLI) battery. Contemporary traction battery packs (also referred to as “electric vehicle battery” or “EVB”) group stacks of battery cells into individual battery modules that are mounted onto the vehicle chassis by a battery pack housing or support tray. Stacked electrochemical battery cells may be connected in series or parallel through use of an electrical interconnect board (ICB). The electrical tabs of the individual battery cells, which project out from the module housing, are bent against and welded to shared busbar plates. A dedicated Battery Pack Control Module (BPCM), through collaborative operation with a Powertrain Control Module (PCM), regulates the opening and closing of battery pack contactors to govern which pack or packs will power the vehicle's traction motor(s) at a given time.

There are four primary types of batteries that have been used in electric-drive vehicles: lithium-class batteries, nickel-metal hydride batteries, lead-acid batteries, and ultracapacitor batteries. As per lithium-class designs, lithium-metal (primary) batteries and lithium-ion (secondary) batteries make up the bulk of commercial lithium battery (LiB) configurations with Li-ion batteries being employed in automotive applications due to their rechargeable capabilities. A conventional lithium-ion battery is composed to two conductive electrodes, an electrolyte material, and a permeable separator, all of which are contained inside an electrically insulated packaging. One electrode serves as a positive electrode (or “cathode”) and the other electrode serves as a negative electrode (or “anode”). Rechargeable lithium-ion batteries operate by reversibly passing lithium ions back and forth between the negative and positive electrodes. The separator, which generally consists of a microporous polymeric membrane, is disposed between the two electrodes to prevent electrical short circuits while also allowing the transport of ionic charge carriers. The electrolyte is suitable for conducting lithium ions and may be in solid form (e.g., solid state diffusion) or liquid form (e.g., liquid phase diffusion). Lithium-ions move from the negative electrode to the positive electrode during discharge of the battery while under load, and in the opposite direction when charging the battery.

### SUMMARY

Presented herein are electrolyte compositions with fluorinated cosolvents, methods for making and methods for using such electrolyte compositions, electrochemical devices containing such electrolyte compositions, and electric-drive vehicles with lithium-ion battery cells using such electrolyte compositions. By way of example, and not limitation, there are presented Li-ion soft polymer pouch cells with an electrolyte system exhibiting improved low-temperature direct current fast charging (DCFC) capabilities. As described in further detail hereinbelow, electrolyte performance directly impacts the DCFC capabilities of a LiB: at low battery temperatures and a relatively high current density, the electrolyte system controls DCFC by chemically regulated de-solvation energy of lithium cations (Li+) from the solvents; at high temperatures and/or low current densities, the electrolyte system controls DCFC by governing electrolyte conductivity. Compared to ethylene carbonate (EC) and propylene carbonate (PC) based solvents, F-cyclic carbonates help to decrease Li+de-solvation energy, i.e. lower Li+-solvent binding energy (E_{bind}), and to improve low temperature DCFC. The electrolyte composition incorporates increased electron withdrawing groups to provide lower E_{bind} and, thus, lower Li+de-solvation energy with fluorine as an electron withdrawing group. For instance, a fluoroethylene carbonate-based electrolyte with −F cosolvents shows comparable conductivity to ethylene carbonate, but with a lower Li+-solvent energy, E_{bind}.

Attendant benefits for at least some of the disclosed concepts include a Li-ion electrochemical device with improved low temperature DC fast charge capabilities. For automotive applications, disclosed rechargeable LiB battery cells with cyclic fluorinated cosolvents help to mitigate vehicle emissions, minimize battery warranty claims, and improve fuel economy (i.e., for HEV configurations). By decoupling battery cell DCFC designs based on temperature-dictated functional requirements and electrolyte conditioning and binding energy design parameters, disclosed features may also help to provide more robust charging characteristics that, in turn, help to boost vehicle range while also reducing driver-borne mileage anxiety.

Aspects of this disclosure are directed to electrolyte systems with fluorinated cosolvents for improved low-temperature DCFC capabilities. In an example, novel electrolyte compositions are presented for lithium-ion electrochemical devices, such as Li-ion battery pouch cells. A representative electrolyte composition includes a lithium salt, a nonaqueous solvent, and a fluorinated cosolvent. The fluorinated cosolvent includes a cyclic carbonate having a cyclic ring and one or more fluorine atoms. Each fluorine atom is bonded either directly or indirectly to the cyclic ring. For instance, a fluorine atom may be bonded: directly to the cyclic ring, to a single atom bonded directly to the cyclic ring, or to a single side chain group bonded directly to the cyclic ring. Disclosed electrolyte compositions and electrochemical devices may be employed in automotive and non-automotive applications alike.

Additional aspects of this disclosure are directed to motor vehicles equipped with lithium-ion soft polymer pouch cells, prismatic cells, cylinder cells, etc., that use electrolyte systems with fluorinated cosolvents. As used herein, the terms “vehicle” and “motor vehicle” may be used interchangeably and synonymously to include any relevant vehicle platform, such as passenger vehicles (ICE, REV, FEV, fuel cell, fully and partially autonomous, etc.), commercial vehicles, industrial vehicles, tracked vehicles, off-road and all-terrain vehicles (ATV), motorcycles, farm equipment, watercraft, aircraft, etc. In an example, an electric-drive vehicle includes a vehicle body with a passenger compartment, multiple road wheels, and other standard original equipment. For electric-drive vehicle applications, one or more electric traction motors operate alone (e.g., for FEV powertrains) or in conjunction with an internal combustion engine assembly (e.g., for HEV powertrains) to selectively drive one or more of the road wheels to thereby propel the vehicle.

Continuing with the discussion of the above example, the vehicle also includes at least one traction battery pack that is mounted onto the vehicle body and operable to power the vehicle powertrain's traction motor(s). The traction battery pack is composed of multiple lithium-ion battery cells, e.g., that are stacked inside a battery pack housing. Each lithium-ion battery cell includes a protective housing, a pair of working electrodes stored within the battery cell housing, and a separator located inside the housing, interposed between the working electrodes. A fluid electrolyte composition is also stored inside the battery cell housing in electrochemical contact with both working electrodes. The electrolyte composition includes a lithium salt, a nonaqueous solvent, and a fluorinated cosolvent. The fluorinated cosolvent includes a cyclic carbonate having a cyclic ring and one or more fluorine atoms. The fluorine atom(s) is/are bonded directly or indirectly to the cyclic ring (e.g., bonded to the cyclic ring, to a single atom that is bonded to the cyclic ring; or to a single side chain group that is bonded to the cyclic ring).

Also presented herein are methods for making/using any of the disclosed electrolyte systems as well as electrochemical devices employing such electrolyte systems. In an example, a lithium-ion electrochemical device, such as a Li-ion secondary battery cell for an electric-drive vehicle, provides improved DC fast-charging capabilities. The electrochemical device includes an electrically insulated outer housing, and a pair of electrically conductive working electrodes located in the housing. A polymeric membrane separator is located in the housing, interposed between the two working electrodes. An ion-conducting electrolyte composition is located in the battery housing in electrochemical contact with both working electrodes. The electrolyte composition includes at least one lithium salt, at least one nonaqueous solvent, and at least one fluorinated cosolvent. The fluorinated cosolvent includes a cyclic carbonate having a cyclic ring and a fluorine atom. The fluorine atom is bonded directly to: the cyclic ring; a single atom bonded directly to the cyclic ring; or a single side chain group bonded directly to the cyclic ring.

For any of the disclosed compositions, devices, methods, and vehicles, the fluorine atom may be bonded directly the cyclic ring of the cyclic carbonate. The cyclic ring may be a five-member pentagonal molecule in which the fluorine atom has a single-valence connection to the ring. In this instance, the fluorinated cosolvent may be a fluoroethylene carbonate (FEC) or a difluoroethylene carbonate (DFEC). A single side chain group, which may be in the nature of a radical group (“R-group” or R), has at least one hydrogen or carbon atom that is bonded directly to the cyclic ring at a discrete location from the fluorine atom. As an example, the R-group may be a carbon-carbon chain, a carbon-carbon-carbon chain, and so on, with at least one carbon atom bonded directly to the cyclic ring. For at least some applications, fluorine atoms may be both bonded directly and indirectly to the cyclic ring of the cyclic carbonate, such as a hexafluoropropylene carbonate.

For any of the disclosed compositions, devices, methods, and vehicles, the fluorine atom is bonded to a single side chain group that is bonded to the cyclic ring. The ring may be a five-member pentagonal molecule in which the fluorine atom has a single-valence connection to the side chain group. In this instance, the fluorinated cosolvent is a trifluoropropylene carbonate (TFPC) or a difluoropropylene carbonate (DFPC). The single side chain group may be a radical group with at least one hydrogen or carbon atom that is bonded directly to the cyclic ring and at least one hydrogen or carbon atom that is bonded directly to the fluorine atom. As noted above, an R-group may be a 2, 3, 4, 5, 6, etc., membered C-chain with at least one carbon atom that is bonded directly to the cyclic ring.

For any of the disclosed compositions, devices, methods, and vehicles, the fluorinated cosolvent may be present in the electrolyte composition in an amount of from about 2.0 parts by weight to about 50.0 parts by weight based on 100 parts by weight of the electrolyte composition. The electrolyte composition may also include a gas-suppressing additive, such as vinylene carbonate (VC), 1,3-propane sultone (PS), methylene methanedisulfonate (MMDS), ethylene sulfate; tris(trimethylsilyl) phosphite (TMSPi), and/or vinyl ethylene carbonate (VEC).

The above summary does not represent every embodiment or every aspect of this disclosure. Rather, the above features and advantages, and other features and attendant advantages of this disclosure, will be readily apparent from the following detailed description of illustrated examples and applicable modes for carrying out the present disclosure when taken in connection with the accompanying drawings and the appended claims. Moreover, this disclosure expressly includes any and all combinations and subcombinations of the elements and features presented above and below.

### BRIEF DESCRIPTION OF THE DRAWINGS

FIG. 1 is a schematic illustration of a representative electric-drive motor vehicle equipped with a hybrid powertrain having an electric traction motor powered by a rechargeable traction battery pack in accordance with aspects of the present disclosure.

FIG. 2 is a schematic illustration of a representative lithium-class electrochemical device including an electrolyte composition in accordance with aspects of the present disclosure.

FIGS. 3 and 4 are two-dimensional chemical structures illustrating the molecular geometry and contents of two representative fluorinated cosolvents in accord with aspects of the disclosed concepts.

FIG. 5 is a graph of binding energy versus charge transfer resistance for different representative electrolyte solvents.

FIG. 6 is a graph of low-temperature DCFC versus high-temperature DCFC illustrating the influence of electrolyte conductivity and binding energy on direct current fast charging capabilities of a lithium-ion electrochemical device.

FIG. 7 is a graph of battery temperature versus battery charge rate at different state of charge values.

The present disclosure is amenable to various modifications and alternative forms, and some representative embodiments are shown by way of example in the drawings and will be described in detail below. It should be understood, however, that the novel aspects of this disclosure are not limited to the particular forms illustrated in the above-enumerated drawings. Rather, the disclosure is to cover all modifications, equivalents, combinations, subcombinations, permutations, groupings, and alternatives falling within the scope of this disclosure as encompassed, for example, by the appended claims.

### DETAILED DESCRIPTION

This disclosure is susceptible of embodiment in many different forms. Representative examples of the disclosure are shown in the drawings and herein described in detail with the understanding that these embodiments are provided as an exemplification of the disclosed principles, not limitations of the broad aspects of the disclosure. To that end, elements and limitations that are described, for example, in the Abstract, Introduction, Summary, Description of the Drawings, and Detailed Description sections, but not explicitly set forth in the claims, should not be incorporated into the claims, singly or collectively, by implication, inference, or otherwise.

For purposes of the present detailed description, unless specifically disclaimed: the singular includes the plural and vice versa; the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “generally,” “approximately,” and the like, may each be used herein in the sense of “at, near, or nearly at,” or “within 0-2% of,” or “within acceptable manufacturing tolerances,” or any logical combination thereof, for example. Lastly, directional adjectives and adverbs, such as fore, aft, inboard, outboard, starboard, port, vertical, horizontal, upward, downward, front, back, left, right, etc., may be with respect to a motor vehicle, such as a forward driving direction of a motor vehicle, when the vehicle is operatively oriented on a horizontal driving surface.

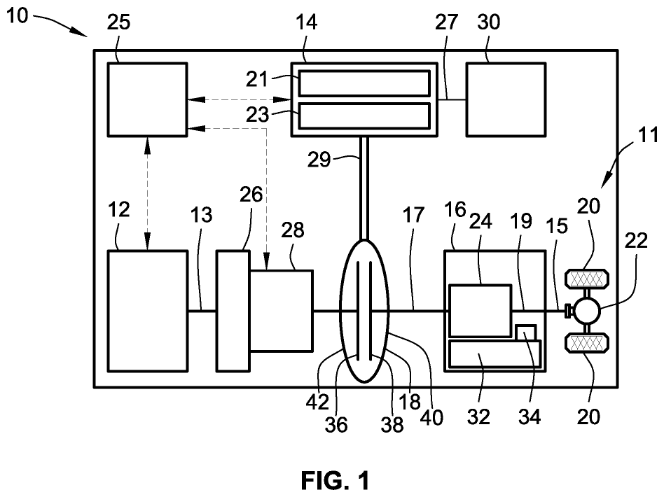

Referring now to the drawings, wherein like reference numbers refer to like features throughout the several views, there is shown in FIG. 1 a schematic illustration of a representative automobile, which is designated generally at 10 and portrayed herein for purposes of discussion as a passenger vehicle with a parallel two-clutch (P2) hybrid-electric powertrain. The illustrated automobile 10—also referred to herein as “motor vehicle” or “vehicle” for short—is merely an exemplary application with which novel aspects and features of this disclosure may be practiced. In the same vein, implementation of the present concepts into a hybrid electric powertrain should also be appreciated as an illustrative use for the novel concepts disclosed herein. As such, it will be understood that facets and options of the present disclosure may be implemented for other electrochemical devices, may be applied to other vehicle powertrain architectures, may be incorporated into any logically relevant type of motor vehicle, and may be utilized for automotive and non-automotive applications alike. Lastly, only select components are shown in the drawings and will be described in additional detail herein. Nevertheless, the vehicles, devices and methods discussed below may include numerous additional and alternative features, and employ other available peripheral components, for achieving the various functions of this disclosure.

The representative vehicle powertrain system is shown in FIG. 1 with a prime mover—represented herein by a restartable internal combustion engine (ICE) assembly 12 and an electric motor/generator unit 14—that is drivingly connected to a driveshaft 15 of a final drive system 11 by a multi-speed automatic power transmission 16. The engine 12 transfers power, preferably by way of torque via an engine crankshaft 13 (“engine output member”), to an input side of the transmission 16. According to the illustrated example, the ICE assembly 12 drives a torsional damper assembly 26 and, through the torsional damper assembly 26, an engine disconnect device 28. This engine disconnect device 28, when operatively engaged, transmits torque received from the ICE assembly 12, by way of the damper 26, to input structure of a torque converter (TC) assembly 18. As the name implies, the engine disconnect device 28 may be selectively disengaged to drivingly disconnect the engine 12 from the motor 14, TC assembly 18, and transmission 16.

The transmission 16, in turn, is adapted to receive, selectively manipulate, and distribute tractive power from the engine 12 and motor 14 to the vehicle's final drive system 11—represented herein by a driveshaft 15, rear differential 22, and a pair of rear road wheels 20—and thereby propel the hybrid vehicle 10. The power transmission 16 and torque converter 18 of FIG. 1 may share a common transmission oil pan or “sump” 32 for supply of hydraulic fluid. A shared transmission pump 34 provides sufficient hydraulic pressure for the fluid to selectively actuate hydraulically activated elements of the transmission 16, the TC assembly 18 and, for some implementations, the engine disconnect device 28. It may be preferable, for at least some embodiments, that the engine disconnect device 28 comprise an active clutching mechanism, such as a controller-actuated selectable one-way clutch (SOWC) or friction-plate clutch, or a passive clutching mechanism, such as a ratchet-and-pawl or sprag-type freewheel OWC assembly.

The ICE assembly 12 operates to propel the vehicle 10 independently of the electric traction motor 14, e.g., in “engine-only” operating modes, or in cooperation with the motor 14, e.g., in “motor-boost” operating modes. Likewise, the motor 14 is operable to propel the vehicle 10 independently of the engine 12, e.g., in “motor-only” operating modes, and to provide auxiliary functionality, e.g., such as engine cranking operations and regenerative braking operations. In the example depicted in FIG. 1, the ICE assembly 12 may be any available or hereafter developed engine, such as a compression-ignited diesel engine or a spark-ignited gasoline or flex-fuel engine, which is readily adapted to provide its available power output typically at a number of revolutions per minute (RPM). Although not explicitly portrayed in FIG. 1, it should be appreciated that the final drive system 11 may take on any available configuration, including front wheel drive (FWD) layouts, rear wheel drive (RWD) layouts, four-wheel drive (4WD) layouts, all-wheel drive (AWD) layouts, six-by-four (6×4) layouts, etc.

FIG. 1 also depicts an electric motor/generator unit 14 that operatively connects via a motor support hub, shaft, or belt 29 (“motor output member”) to torque converter 18, and via torque converter 18 to an input shaft 17 (“transmission input member”) of the transmission 16. The motor/generator unit 14 may be directly coupled to a TC input shaft or drivingly mounted to a housing portion of the torque converter 18. The electric motor/generator unit 14 is composed of an annular stator assembly 21 circumscribing and concentric with a cylindrical rotor assembly 23. Electric power is provided to the stator 21 through electrical conductors or cables 27 that pass through the motor housing via suitable sealing and insulating feedthroughs (not illustrated). Conversely, electric power may be provided from the MGU 14 to an onboard traction battery pack 30, e.g., through regenerative braking. Operation of any of the illustrated powertrain components may be governed by an onboard or remote vehicle controller, such as programmable electronic control unit (ECU) 25. While shown as a P2 hybrid-electric architecture with a single motor in parallel power-flow communication with a single engine assembly, the vehicle 10 may employ other powertrain configurations, such as P0, P1, P2.5, P3 and P4 hybrid powertrains, any of which may be adapted for an REV, PHEV, range-extended hybrid vehicle, fuel-cell hybrid vehicle, FEVs, etc.

Power transmission 16 may use differential gearing 24 to achieve selectively variable torque and speed ratios between transmission input and output shafts 17 and 19, respectively, e.g., while sending all or a fraction of its power through the variable elements. One form of differential gearing is the epicyclic planetary gear arrangement. Planetary gearing offers the advantage of compactness and different torque and speed ratios among all members of the planetary gearing subset. Traditionally, hydraulically actuated torque establishing devices, such as clutches and brakes, are selectively engageable to activate the aforementioned gear elements for establishing desired forward and reverse speed ratios between the transmission's input and output shafts 17, 19. While envisioned as an 8-speed automatic transmission, the power transmission 16 may optionally take on other functionally appropriate configurations, including Continuously Variable Transmission (CVT) architectures, automated-manual transmissions, etc.

Hydrokinetic torque converter assembly 18 of FIG. 1 operates as a fluid coupling for operatively connecting the engine 12 and motor 14 with the internal epicyclic gearing 24 of the power transmission 16. Disposed within an internal fluid chamber of the torque converter assembly 18 is a bladed impeller 36 juxtaposed with a bladed turbine 38. The impeller 36 is situated in serial power-flow fluid communication with the turbine 38, with a stator (not shown) interposed between the impeller 36 and turbine 38 to selectively alter fluid flow therebetween. The transfer of torque from the engine and motor output members 13, 29 to the transmission 16 via the TC assembly 18 is through stirring excitation of hydraulic fluid, such as transmission oil, inside the TC's internal fluid chamber caused by rotation of the impeller and turbine 36, 38 blades. To protect these components, the torque converter assembly 18 is constructed with a TC pump housing, defined principally by a transmission-side pump shell 40 fixedly attached, e.g., via electron beam welding, MIG or MAG welding, laser welding, and the like, to an engine-side pump cover 42 such that a working hydraulic fluid chamber is formed therebetween.

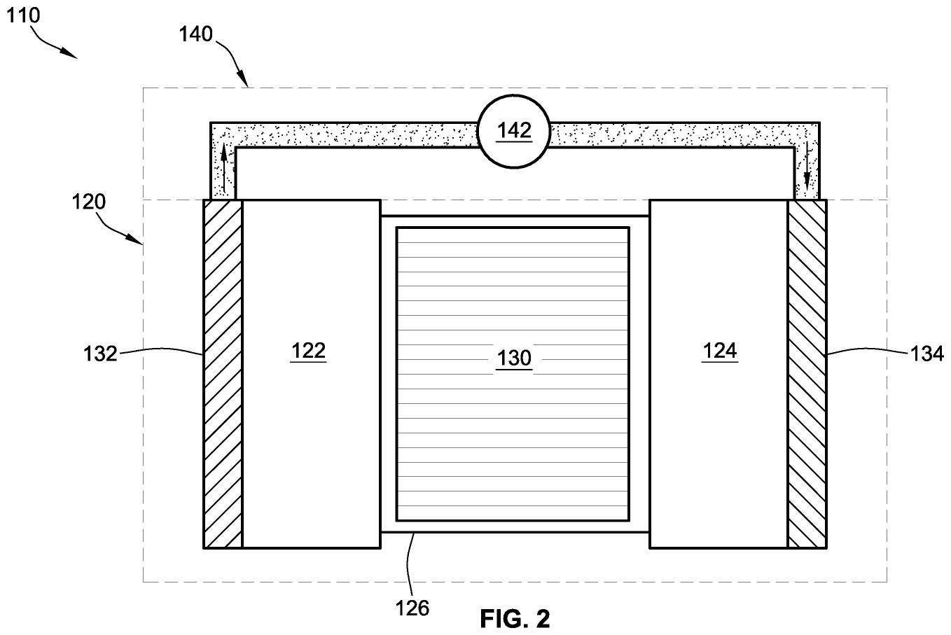

Presented in FIG. 2 is an exemplary electrochemical device in the form of a rechargeable (secondary) lithium-ion battery 110 that facilitates direct current fast charging (DCFC) for a desired electrical load, such as automobile 10 of FIG. 1. Battery 110 includes a pair of electrically conductive electrodes—a first working (negative or anode) electrode 122 and a second (positive or cathode) working electrode 124—packaged inside a liquid-tight protective outer housing 120. In at least some configurations, the battery housing 120 may be an envelope-like pouch that is formed of aluminum foil or other suitable sheet material, both sides of which may be coated with a polymeric material that insulates the metal from the internal cell elements and from any neighboring battery cells. Reference to either working electrode 122, 124 as an “anode” or “cathode” or, for that matter, as “positive” or “negative” is not intended to limit the electrodes 122, 124 to a particular polarity as the electrical polarity may change depending on whether the battery 110 is being charged or discharged. Although FIG. 2 illustrates the components of a single battery cell unit inserted within the battery housing 120, it should be appreciated that the housing 120 may stow therein a sandwiched stack of multiple cell units (e.g., five to fifteen units).

With continuing reference to FIG. 2, anode electrode 122 may be fabricated from a material that is capable of receiving lithium ions during a battery charging operation, and expelling lithium ions during a battery discharging operation. Exemplary anode materials suitable for this function may include, but are not limited to, carbon materials (e.g., graphite, coke, soft carbons, and hard carbons) and metals (e.g., Si, Al, Sn, and/or alloys thereof). In this regard, the cathode electrode 124 may be fabricated from a material that is capable of expelling lithium ions during a battery charging operation, and receiving lithium ions during a battery discharging operation. The cathode 240 material may include, for instance, a lithium metal oxide, phosphate, or silicate, such as LiMO2 (M=Co, Ni, Mn, Al, Mg, or any combination or two or more thereof); LiM2O4 (M=Mn, Ti, or any combination thereof); LiMPO4 (M=Fe, Mn, Co, or any combination thereof); and LiMxM′2-xO4 (M, M′=Mn or Ni). It may be desirable that the anode electrode 122 and cathode electrode 124 be fabricated from materials that exhibit a long cycle life and calendar life, and do not experience significant resistance increase throughout the life of the battery.

Disposed inside the battery housing 120 between the two electrodes 122, 124 is a porous separator 126, which may be in the nature of one or more microporous or nanoporous polymeric sheets. The porous separator 126 is shown immersed in a non-aqueous liquid electrolyte composition 130 that may directly contact the negative and positive electrodes 122, 124. As shown, a negative electric current collector 132 is located adjacent and operatively connected to the negative electrode 122, and a positive electric current collector 134 is located adjacent and operatively connected to the positive electrode 124. These two current collectors 132, 134 respectively collect and conduct free electrons to and from an electrical circuit 140. An interruptible external circuit 140 and load 142 connects the negative electrode 122, through its respective current collector 132, with the positive electrode 124, through its respective current collector 134. Separator 126 may be a sheet-like structure that is composed of a porous polyolefin membrane, e.g., with a porosity of about 35% to 65% and a thickness of approximately 10-100 microns. In addition, the separator 126 may be modified, for instance, by the application of electrically non-conductive ceramic particles (e.g., silica) that are coated on the porous membrane surfaces.

Sandwiched between the two electrodes 122, 124, the porous separator 126 may operate as both an electrical insulator and a mechanical support structure to prevent the electrodes 122, 124 from physically contacting each other and, thus, the occurrence of a short circuit. In addition to providing a physical barrier between the electrodes 122, 124, the porous separator 126 may provide a minimal resistance path for internal passage of lithium ions (and related anions) during cycling of the lithium ions to facilitate functioning of the battery 110. In lithium-ion batteries, the lithium may intercalate and/or alloy in the electrodes' active materials; conversely, in a lithium sulfur battery, instead of intercalating or alloying, the lithium may dissolve from the negative electrode and migrate to the positive electrode where it may react and plate during battery discharge. For some optional configurations, the porous separator 126 may be a microporous polymeric separator including a polyolefin. In this regard, the polyolefin may be a homopolymer, which is derived from a single monomer constituent, or a heteropolymer, which is derived from more than one monomer constituent, and may be either linear or branched.

Operating as a rechargeable electric storage system, battery 110 generates electric current that is transmitted to one or more loads 142 operatively connected to the external circuit 140. While the load 142 may be any number of electrically powered devices, a few non-limiting examples of power-consuming load devices include an electric motor for a hybrid electric vehicle or an all-electric vehicle, a laptop or tablet computer, a cellular phone, and cordless power tools or appliances. The battery 110 may include a variety of other components that, while not depicted herein for simplicity and brevity, are nonetheless readily commercially available. For instance, the battery 110 may include one or more gaskets, terminal caps, electrical tabs, battery terminals, and any other conventional components or materials that may facilitate a desired use of the battery 110, for example. Moreover, the size and shape and operating characteristics of the battery 110 may vary depending on the particular application for which it is designed.

With renewed reference to FIG. 2, the electrolyte composition 130 is capable of conducting lithium ions back-and-forth across the separator 126 between the negative electrode 122 and the positive electrode 124. The electrolyte composition 130 may be a mixture of organic carbonates, generally composed of a lithium salt, a primary solvent, and a secondary solvent. In at least some applications, the lithium salt is a readily soluble ionic salt, the primary solvent is a non-aqueous organic solvent, and the cosolvent is an F-cyclic carbonate. The electrolyte composition 130 may further include one or more appropriate additives, such as those additives that help to increase cycle life, battery stability, lithium ion mobility, etc. For instance, composition 130 may include organic borate-based electrolyte additives, silane electrolyte additives, and combinations thereof. As another non-limiting example, the electrolyte composition 130 may incorporate a suitable gas-suppressing additive. A non-exclusive list of additives that can be used to suppress gassing includes: vinylene carbonate (VC); 1,3-propane sultone (PS); methylene methanedisulfonate (MMDS); ethylene sulfate; tris(trimethylsilyl) phosphite (TMSPi); vinyl ethylene carbonate (VEC), and any combination thereof.

The lithium salt is a relatively light, highly reactive molecular structure that readily “loses” its outermost electron, facilitating ion flow across the electrodes 122, 124 in the electrochemical device 110. Electrolyte composition 130, when employed by a lithium-ion secondary battery, may comprise a single lithium salt or multiple electrolyte salts. The particular electrolyte salt(s) and their concentration in the electrolyte composition 130 will influence the oxidative stability of the resulting electrolyte. Non-limiting examples of suitable lithium salts include: lithium bis(trifluoromethane sulfone)imide, lithium hexafluorophosphate, lithium bis(fluorosulfonyl)imide (LiFSI), lithium hexafluoroarsenate, lithium bis(trifluorosulfonylimide), lithium trifluoromethanesulfonate, lithium bis(oxalate borate), lithium fluoroalkylsufonimides, lithium perchlorate, lithium fluoroarylsufonimides, lithium tris(trifluoromethylsulfonylimide)methide, lithium tetrafluoroborate, lithium tetrachloroaluminate, lithium chloride, and any combinations thereof. The selection of the particular salt or salts may be based on a desired solubility, ion mobility, stability, etc.

The lithium salt is dissolved in a non-aqueous, liquid organic solvent or mixture of solvents to form an electrolyte solution. The non-aqueous solvent may generally comprise two or more components: a first solvent component provides, for example, desired levels of solubility of the lithium salt(s); and a second component that may be liquid at room temperature and provides, for example, increased ion mobility. For high voltage battery applications, ethylene carbonate may be used as a first solvent component with desired properties. The second solvent component may be miscible and viscous, and selected to achieve desired properties over the operating temperature range including maintaining ionic conductivity. The solvent may be selected from: ethylene carbonate, propylene carbonate, diethyl carbonate, butylene carbonate, dimethyl carbonate, ethylmethyl carbonate, methylpropyl carbonate, butylmethyl carbonate, ethylpropyl carbonate, dipropyl carbonate, cyclopentanone, sulfolane, dimethyl sulfoxide, 3-methyl-1,3-oxazolidine-2-one, γ-butyrolactone, 1,2-di-ethoxymethane, 2-methyltetrahydrofuran, 1,3-dioxolane, methyl acetate, ethyl acetate, nitromethane, 1,3-propane sultone, γ-valerolactone, methyl isobutyryl acetate, 2-methoxyethyl acetate, 2-ethoxyethyl acetate, dimethoxyethane, diethyl oxalate, or an ionic liquid, and any combination thereof.

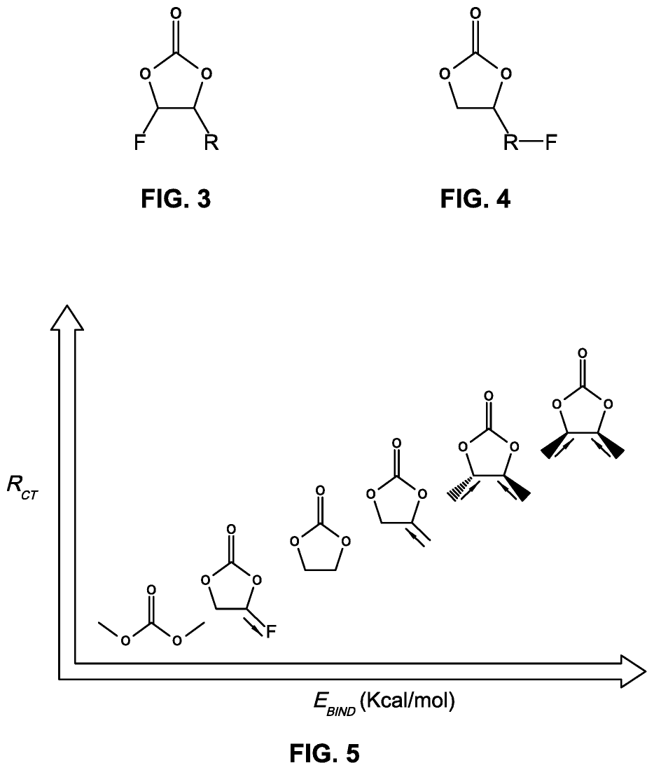

Disclosed electrolyte systems help to improve the DCFC operation of the electrochemical device by decoupling the battery's functional characteristics and design parameters under different charging conditions. By way of example, and not limitation, for DCFC at low battery temperatures and relatively high current densities, the electrolyte's de-solvation of lithium cations (Li+) from the electrolyte solvent(s) governs. For DCFC under other charging conditions, e.g., at elevated battery temperatures and low current densities, the electrolyte's conductivity, rather than the Li+-solvent's de-solvation energy, governs. In order to improve the DCFC at lower temperatures, the electrolyte composition employs a secondary cosolvent in the form of a cyclic fluorinated carbonate to fully or partially replace the cyclic organic carbonates (e.g., ethylene carbonate, propylene carbonate, etc.) in which the fluorine atom is either bonded directly to the organic carbonate's cyclic ring (FIG. 3) or to a single atom or a single side chain group that is bonded directly to the cyclic ring (FIG. 4). In general, other halogen atoms do not provide the same benefits as, and thus cannot be substituted for, fluorinated carbonates because the fluorine atom helps to withdraw electrons to decrease E_{bind} and boost DCFC. For at least some embodiments, a concentration of the fluorinated cosolvent is in a range from about 2% to about 50% by weight or, for some desirable compositions, from about 5% to about 40%, or for some preferred configurations, from 10% to 30%.

To achieve the aforementioned features, the fluorine atom in the fluorinated carbonate is connected to a specific carbon and, concomitantly, a desired location on the cyclic ring. As a representative example, FIG. 3 illustrates a heterocyclic organic molecular structure in which the fluorine atom is directly connected to the cyclic ring of the organic carbonate via a single bond. For this structure, the annular atoms include at least two oxygen atoms (O), while a third oxygen atom has a double-valence bond with the ring. In this example, the ring is a five-member pentagonal molecule in which the fluorine atom has a single-valence connection to the ring. As shown, the fluorinated cosolvent may be either a fluoroethylene carbonate (FEC) or a difluoroethylene carbonate (DFEC), as some non-limiting examples. A single side chain group, shown as a radical group R in FIG. 3, is bonded, e.g., via single valence, to the cyclic ring at a discrete location from the −F atom. An R-group R may be a carbon-carbon chain, a carbon-carbon-carbon chain, or other suitable multimember C-chain group with at least one carbon atom thereof that is bonded directly to the cyclic ring.

FIG. 4 illustrates another representative heterocyclic organic molecular structure for a fluorinate cyclic carbonate; however, the fluorine atom in this example is connected to the cyclic ring by an intermediate side chain group. Similar to the structure presented in FIG. 3, the ring structure of FIG. 4 is a five-member pentagonal molecule, and the single side chain group is a radical group that is bonded directly to the cyclic ring. As another point of similarity, the R-group R may be a multimember C-chain group with at least one carbon atom thereof that is bonded directly to the ring. By way of comparison with FIG. 3, the fluorine atom of FIG. 4 has a single-valence connection directly to the C-chain, and the C-chain has a single-valence connection directly to the cyclic ring. As shown, the fluorinated cosolvent may be either a trifluoropropylene carbonate (TFPC) or a difluoropropylene carbonate (DFPC), as some non-limiting examples. When referencing FIGS. 3 and 4, R should not be confused with the ideal gas constant, the one-letter abbreviation for the amino acid arginine, or a designation of absolute configuration.

The F-cyclic carbonates of FIGS. 3 and 4 help to decrease Li+-solvent binding energy and, in turn, decrease Li+de-solvation energy to thereby improve low temperature DCFC. In general, cyclic carbonates strongly bind the Li+ to form the Li+-solvents cluster; as such, it takes a large amount of energy to free Li+ from the cyclic solvents. Modifying the solvent molecule by adding fluorine to the ring reduces the amount of energy needed for Li+ to be freed and abates the resistivity of the cell, especially at low temperatures and high charge currents when Li+-solvent de-solvation becomes the limiting step.

Turning next to FIG. 5, there is shown a graph of binding energy E_{Bind} versus charge transfer resistance R_{CT} for different representative electrolyte solvents. In general, this graph demonstrates that higher Li+-solvent binding energies lead to higher charge transfer resistances. Modeling data reveals that more electron donating groups lead to a higher binding energy and, consequently, a higher Li+de-solvation energy and decreased DCFC. With the introduction of fluorine—an electron withdrawing group—into the ring structure, binding energy is reduced and charge transfer resistance is reduced. What's more, an FEC-based electrolyte, which also possesses good DCFC at elevated temperatures, compares favorably to EC-based electrolyte.

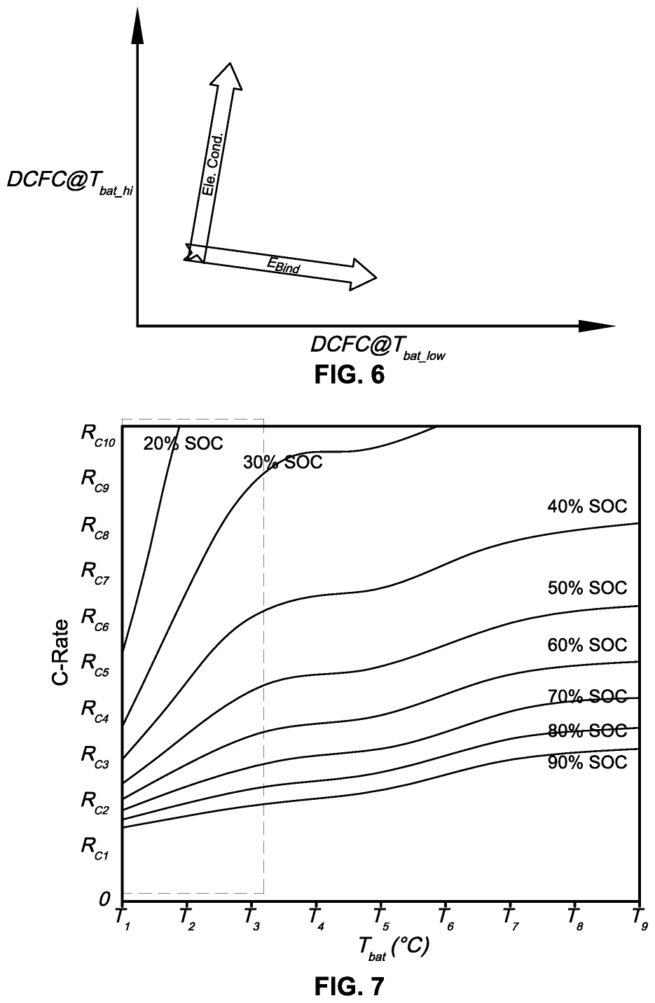

FIG. 6 graphically illustrates DC fast charging of a lithium-ion battery at low battery temperatures (DCFC@T_{bat_low}) versus DC fast charging of a lithium-ion battery at high battery temperatures (DCFC@T_{bat_hi}). This graph demonstrates the influence of electrolyte conductivity (Ele.Cond.) and binding energy (E_{Bind}) on direct current fast charging capabilities of a lithium-ion electrochemical device. At high temperatures, DCFC may be predominantly controlled by electrolyte conductivity, whereas at low temperatures DCFC may be predominantly controlled by the desolvation of Li+ from solvents.

With reference next to FIG. 7, battery temperature T_{bat} is graphed as a function of battery charge rate (C-rate) at different battery SOCs. As noted above, DC fast charging has been shown to be predominantly controlled by Li+ desolvation from the solvents at low temperatures (e.g., T_{bat}<20° C.). Designing a low binding energy cluster, such as those described above, may therefore be crucial for DCFC. According to this graph, there is a noticeable drop in DCFC from T₁ to T₃ (e.g., 10-20° C.) at higher current densities. The activation energy (Eₐ) of DCFC under these charging conditions is calculated to be about 60 kJ/mol, which is typically controlled by the de-solvation of Li+ from the solvent molecules due to strong binding of EC/PC with Li+. For other charging conditions, such as a low current density and a high batter temperature (e.g., T_{bat}>20° C.), DCFC may be predominantly controlled by electrolyte conductivity, e.g., with Eₐ of 7 to 10 kJ/mol.

Example 1: 1M LiPF6-FEC:EMC (25:75, wt % ratio), with gassing suppressing additives.

Example 2: 1M LiPF6-DFEC:EMC (25:75, wt % ratio), with gassing suppressing additives.

Example 3: 1M LiPF6-TFPC:EMC (25:75, wt % ratio), with gassing suppressing additives.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

What is claimed:

1. An electrolyte composition for a lithium-ion electrochemical device, the electrolyte composition comprising:
a lithium salt;
a nonaqueous solvent; and
a fluorinated cosolvent including a cyclic carbonate having a cyclic ring and a fluorine atom,
wherein the fluorine atom is bonded:
directly to the cyclic ring;
directly to a single atom bonded directly to the cyclic ring; or
directly to a single side chain group bonded directly to the cyclic ring.

2. The electrolyte composition of claim 1, wherein the fluorine atom is bonded directly to the cyclic ring.

3. The electrolyte composition of claim 2, wherein the fluorinated cosolvent includes a fluoroethylene carbonate (FEC) or a difluoroethylene carbonate (DFEC) represented by structure (I):

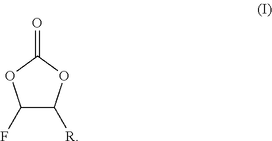

4. The electrolyte composition of claim 3, wherein R is a radical group with at least one hydrogen atom or carbon atom bonded directly to the cyclic ring.

5. The electrolyte composition of claim 4, wherein the radical group R is a multimember C-chain group with at least one carbon atom bonded directly to the cyclic ring.

6. The electrolyte composition of claim 1, wherein the fluorine atom is bonded to the single side chain group bonded directly to the cyclic ring.

7. The electrolyte composition of claim 6, wherein the fluorinated cosolvent includes a trifluoropropylene carbonate (TFPC) or a difluoropropylene carbonate (DFPC) represented by structure (II):

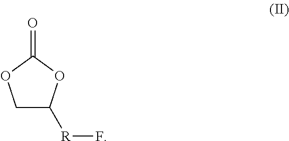

8. The electrolyte composition of claim 7, wherein the single side chain group is a radical group R with at least one hydrogen atom or carbon atom bonded directly to the cyclic ring.

9. The electrolyte composition of claim 8, wherein the radical group R is a multimember C-chain group with at least one carbon atom bonded directly to the cyclic ring.

10. The electrolyte composition of claim 1, wherein the fluorinated cosolvent is present in the electrolyte composition in an amount of from about 2.0 parts by weight to about 50.0 parts by weight based on 100 parts by weight of the electrolyte composition.

11. The electrolyte composition of claim 1, further comprising a gas-suppressing additive including: vinylene carbonate (VC); 1,3-propane sultone (PS); methylene methanedisulfonate (MMDS); ethylene sulfate; tris(trimethylsilyl) phosphite (TMSPi); vinyl ethylene carbonate (VEC); or a combination of two or more thereof.

12. The electrolyte composition of claim 1, wherein the fluorine atom includes a first fluorine atom bonded directly to the cyclic ring and a second fluorine atom bonded directly to the single side chain group bonded directly to the cyclic ring.

13. An electric-drive vehicle, comprising:
a vehicle body with multiple road wheels;
an electric traction motor attached to the vehicle body and operable to drive one or more of the road wheels to thereby propel the vehicle;
a traction battery pack attached to the vehicle body and operable to power the electric traction motor, the traction battery pack including a plurality of lithium-ion battery cells each comprising:
a battery cell housing;
first and second working electrodes stored within the battery cell housing;
a separator stored within the battery cell housing and interposed between the first and second working electrodes; and
an electrolyte composition stored within the battery cell housing in electrochemical contact with the first and second working electrodes, the electrolyte composition including a lithium salt, a nonaqueous solvent, and a fluorinated cosolvent including a cyclic carbonate having a cyclic ring and a fluorine atom, wherein the fluorine atom is bonded to the cyclic ring, to a single atom bonded to the cyclic ring, or to a single side chain group bonded to the cyclic ring.

14. A lithium-ion electrochemical device, comprising:
an electrically insulated housing;
an electrically conductive first working electrode located in the housing;
an electrically conductive second working electrode located in the housing;
a polymeric membrane separator located in the housing and interposed between the first and second working electrodes; and
an electrolyte composition located in the housing in electrochemical contact with the first and second working electrodes, the electrolyte composition including a lithium salt, a nonaqueous solvent, and a fluorinated cosolvent, the fluorinated cosolvent including a cyclic carbonate having a cyclic ring and a fluorine atom,
wherein the fluorine atom is bonded to the cyclic ring, to a single atom bonded to the cyclic ring, or to a single side chain group bonded to the cyclic ring.

15. The lithium-ion electrochemical device of claim 14, wherein the fluorinated cosolvent is a fluoroethylene carbonate (FEC) or a difluoroethylene carbonate (DFEC) represented by structure (I):

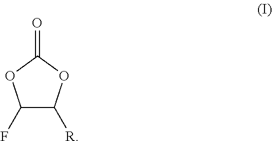

16. The lithium-ion electrochemical device of claim 15, wherein R is a radical group including a 3-C chain with at least one carbon atom bonded to the cyclic ring of the cyclic carbonate.

17. The lithium-ion electrochemical device of claim 14, wherein the fluorinated cosolvent is a trifluoropropylene carbonate (TFPC) or a difluoropropylene carbonate (DFPC) represented by structure (II):

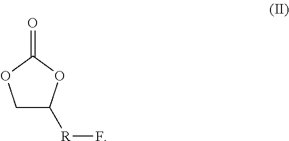

18. The lithium-ion electrochemical device of claim 17, wherein the single side chain group is a radical group R including a 3-C chain with at least one carbon atom bonded to the cyclic ring of the cyclic carbonate.

19. The lithium-ion electrochemical device of claim 14, wherein the fluorinated cosolvent is present in the electrolyte composition in an amount of from about 2.0 parts by weight to about 50.0 parts by weight based on 100 parts by weight of the electrolyte composition.

20. The lithium-ion electrochemical device of claim 14, wherein the electrolyte composition further comprises a gas-suppressing additive including: vinylene carbonate (VC); 1,3-propane sultone (PS); methylene methanedisulfonate (MMDS); ethylene sulfate; tris(trimethylsilyl) phosphite (TMSPi); vinyl ethylene carbonate (VEC); or a combination of two or more thereof.
